(19) United States
(12) Patent Application Publication
(10) Pub. No.: US 2006/0026811 A1
(43) Pub. Date: Feb. 9, 2006

(54) Faucet cartridge removal apparatus and method

(76) Inventor: William E. Shultz SR., Lombard, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/913,516

(22) Filed: Aug. 6, 2004

(51) Int. Cl. B23P 19/04

(52) U.S. Cl. 29/221.6; 29/249; 29/278; 81/27; 408/83.5

(57) ABSTRACT

Apparatus and method for removing the most difficult-to-remove plumbing valve cartridges from plumbing conduits. The apparatus includes an elongated, externally threaded shaft adapted to reach into a plumbing conduit to secure the elongated shaft to an internally threaded portion of the valve cartridge. A slide hammer that is easily and quickly movable, manually, that surrounds the elongated shaft at a centrally disposed aperture exerts longitudinal force on the shaft for freeing and removing the valve cartridge from the plumbing cartridge. In another embodiment, the elongated shaft also includes second, larger diameter external threads for removing the most difficult-to-remove valve cartridges when the longitudinal force exerted on the valve cartridge removes the internal valve cartridge structure, leaving a tubular outer cartridge casing that has bonded to the plumbing conduit. For removal of the tubular outer cartridge casing, after separation of the internal valve cartridge structure, a tapping device capable of forming internal threads on a reduced diameter portion of the cartridge casing cuts to internal threads on the bonded cartridge casing.

### FIELD OF THE INVENTION

The present invention is directed to a faucet valve cartridge removal tool for removing a faucet valve cartridge from a plumbing conduit. In one embodiment, the tool includes an elongated shaft having a gripping handle and an externally threaded stem adapted to be secured to a threaded aperture of the valve cartridge and includes a slide hammer for exerting longitudinal force on the threaded stem for valve cartridge removal. In another embodiment, the invention is directed to a valve cartridge removal kit which includes the threaded stem as well as a tapping device for forming internal threads on an inside diameter of the valve cartridge after removal of internal valve structure by use of the threaded stem and slide hammer tool.

### BACKGROUND OF THE INVENTION AND PRIOR ART

A very popular household faucet, made by Moen Corporation, is manufactured to include a removable valve cartridge so that when parts of the valve, e.g., packing, o-rings or the like become worn, as in other faucet designs, the entire cartridge can be relatively easily removed and replaced with a new cartridge by the homeowner. Such Moen faucets containing removable valve cartridges have been sold for decades and one or more tools are presently sold for the purpose of removing the worn cartridge. Such prior art tools include an elongated stem having a threaded distal end adapted to engage internal threads within the valve cartridge so that a pulling force exerted on the tool, theoretically, will remove the entire valve cartridge. Often, however, the outer surface of the valve cartridge becomes fixed to the plumbing conduit by oxidation of the valve cartridge outer surface or by particles becoming lodged between the valve cartridge and the plumbing conduit so that the longitudinal force exerted for the purpose of removing the entire valve cartridges sometimes only removes a rotatable, internal valve structure of the valve cartridge leaving an outer valve cartridge casing or housing stuck to the plumbing conduit. At this point, there is no structure for the prior art tools to grasp onto in order to remove the outer valve cartridge casing and the homeowner must often call a plumber for valve cartridge casing removal before the new cartridge can be installed.

One or more of the above problems of the prior art valve cartridge removal tool have been eliminated in accordance with the tool and kit described herein by including a slide hammer on the removal tool and by providing a tapping device for cutting internal threads on the internal diameter of the outer valve cartridge housing in case the internal valve cartridge structure becomes removed separately from the entire valve cartridge during the removal process.

### SUMMARY

In brief, the apparatus and methods described herein provide fail-safe removal of the most difficult-to-remove plumbing valve cartridges from plumbing conduits. The apparatus includes an elongated, externally threaded shaft adapted to reach into a plumbing conduit to secure the elongated shaft to an internally threaded portion of the valve cartridge. A slide hammer that is easily and quickly movable, manually, that surrounds the elongated shaft at a centrally disposed aperture exerts longitudinal force on the shaft for freeing and removing the valve cartridge from the plumbing cartridge. In another embodiment, the elongated shaft also includes second, larger diameter external threads for removing the most difficult-to-remove valve cartridges when the longitudinal force exerted on the valve cartridge removes the internal valve cartridge structure, leaving a tubular outer cartridge casing that has bonded to the plumbing conduit.

For removal of the tubular outer cartridge casing, after separation of the internal valve cartridge structure, a tapping device capable of forming internal threads on a reduced diameter portion of the cartridge casing cuts internal threads on the bonded cartridge casing. In some instances, the bonded cartridge casing can be removed directly by exciting longitudinal force through a handle of the tapping device. However, with the most difficult-to-remove, most severely bonded cartridge casings, the tapping device is unscrewed from the formed internal threads and the elongated shaft is connected to the formed threads, at the second, larger diameter external threads so that the slide hammer can be used to exert greater, sudden longitudinal force on the cartridge casing to achieve cartridge casing removal.

A tubular tapping device guide also is provided to insure that the tapping device cuts internal threads relatively evenly completely around the internal diameter of the reduced-diameter portion of the cartridge casing. In a preferred embodiment, the elongated shaft, having an integral gripping handle; the side hammer adapted to quickly slide longitudinally over the elongated shaft; the tapping device; and the tubular tapping device guide all are included in a tool kit.

Accordingly, one aspect of the apparatus, tool kit, and methods described herein is to provide an apparatus capable of removing a faucet valve cartridge from a plumbing conduit.

Another aspect of the apparatus, tool kit, and methods described herein is to provide a tool kit capable of first removing internal valve structure from a faucet valve cartridge; then cutting internal threads within an internal diameter of a remaining valve cartridge casing; and then removing the valve cartridge casing separately from the internal valve cartridge structure.

Yet another aspect of the apparatus, tool kit, and methods described herein is to provide apparatus having a slide hammer disposed to easily and quickly slide longitudinally surrounding an elongated shaft that is threadedly connected to a valve cartridge to provide sufficient force to remove internal valve structure from the valve cartridge, or in some cases, remove the entire valve cartridge from a plumbing conduit.

Still another aspect of the apparatus, tool kit, and methods described herein is to provide a tool kit for removing a valve cartridge from a plumbing conduit including a first tool having a gripping handle and an externally threaded, elongated shaft adapted for threaded engagement with an internally threaded aperture in an internal valve structure portion of the valve cartridge; a slide hammer slideably mounted over the elongated shaft of the first tool; and a second tool comprising a tapping device, having a gripping handle, for cutting internal threads into an inside diameter of a tubular outer valve cartridge casing after removing the internal valve structure portion of the valve cartridge.

Another aspect of the apparatus, tool kit, and methods described herein is to provide a tap guide to insure relatively even cutting of threads into an internal diameter of the outer valve cartridge casing. The above and other aspects and advantages of the apparatus, tool kit, and methods described herein will become more apparent from the following detailed description of the preferred embodiments, taken in conjunction with the drawings.

### BRIEF DESCRIPTION OF THE DRAWINGS

FIG. 1 is a perspective view of a tool adapted for complete removal of a faucet valve cartridge including a removable, small diameter externally threaded portion; an elongated shaft having a second, larger diameter externally threaded portion on a distal end of the elongated shaft; and a slide hammer;

FIG. 2 is a perspective view of a tapping device adapted to cut internal threads on an internal, reduced-diameter portion of a valve cartridge casing for removal of the cartridge casing after separating and removing internal valve structure from the valve cartridge;

FIG. 3 is a perspective view of a tubular tapping device guide sized to fit within the cartridge casing, after removal of internal valve cartridge structure, that guides the tapping device, showing in FIG. 2, for cutting internal threads evenly around the entire internal diameter of a reduced-diameter portion of the cartridge casing;

FIG. 4 is a partially-broken-away perspective view showing a faucet valve cartridge in place within a plumbing conduit; and

FIG. 5 is a partially-broken-away perspective view showing the tapping device of FIG. 2 being removed from the bonded cartridge casing (after the internal valve cartridge structure was removed by the apparatus of FIG. 1) after the tapping device was rotated to form internal threads in a reduced-diameter internal portion of the cartridge casing. The formed internal threads are sized for connection to the larger diameter external threads on the elongated shaft of the apparatus of FIG. 1.

### DETAILED DESCRIPTION OF THE PREFERRED EMBODIMENTS

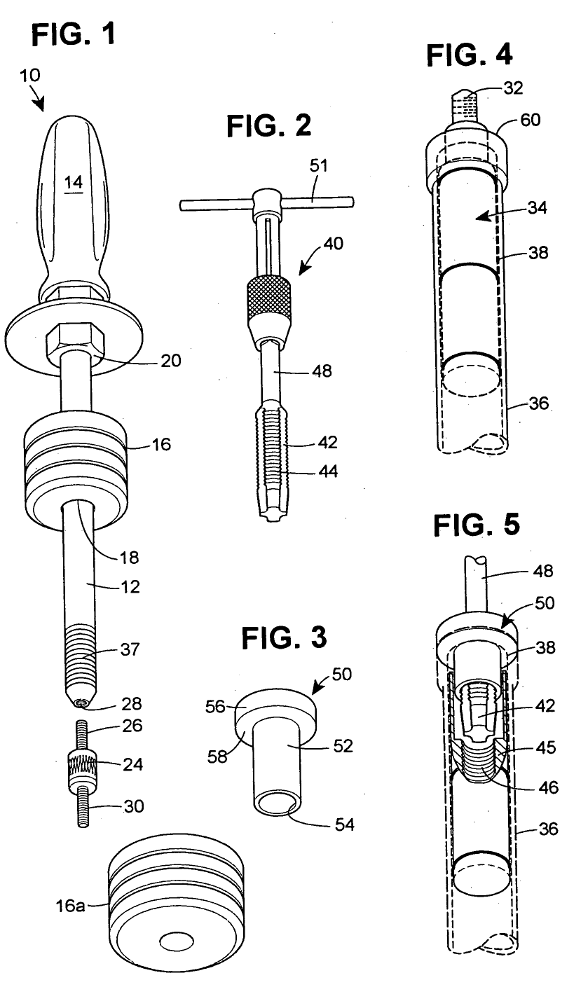

Referring now to the drawings, FIGS. 1-3 show valve cartridge removal tools, 10, 40, and 50, preferably contained together in the form of a tool kit, for removing a faucet valve cartridge from a plumbing conduit. Referring now to FIG. 1, a first tool 10, includes an elongated shaft 12, adapted for insertion into a plumbing conduit, that is integrally connected to a gripping handle 14; a solid steel slide hammer 16, having a central aperture 18 larger than a diameter of the elongated shaft 12 so that the slide hammer 16 is easily slidable longitudinally over the elongated shaft 12; a slide hammer stop surface 20 for receiving longitudinal force exerted by sliding the slide hammer 16 against the stop surface 20 to exert longitudinal removal force to a valve cartridge; a removable valve cartridge connecting member 24 connectable at one externally threaded end 26 to internal threads 28 of the elongated shaft 12, and having an opposite, second end having external, relatively smaller diameter threads 30 adapted for threaded engagement into internal threads 32 in an exposed end of the valve cartridge 34 (FIG. 4) that is disposed within a plumbing conduit 36. Elongated shaft 12 also includes larger diameter external threads 37 for threaded connection to formed threads in an outer valve cartridge casing, as will be described in more detail hereinafter.

In order to remove the valve cartridge 34 from the plumbing conduit 36, the valve cartridge connecting member is threadedly connected to the elongated shaft 12 by threading the external threads 26 into the internal threads 28 of the elongated shaft 12. The exposed, external threads 30, on the distal end of the valve cartridge attachment member 24 then are internally threaded into the internal threads 32 of the valve cartridge 34 (FIG. 4) for exerting longitudinal, upward force on the valve cartridge 34 for its removal. In accordance with an important feature, after attachment of the external threads 30 into the valve cartridge internal threads 32, the slide hammer 16 is slid upwardly over the elongated shaft 12 to contact the stop surface 20 for a sudden and substantial longitudinal force applied on the valve cartridge 34 for its removal. In the preferred embodiment, a heavier slide hammer 16a is provided in the event that the lighter slide hammer's insufficient to free the valve cartridge from the plumbing conduit. As earlier mentioned, often times substantial longitudinal force on the valve cartridge 34 will separate an internal valve structure portion of the valve cartridge 34 from its tubular outer valve cartridge casing 38, leaving the tubular outer casing 38 stuck in the plumbing conduit 36. In accordance with the kit embodiment of the tools and methods for valve cartridge removal described herein, the kit is provided with a tap 40 having an internal thread-cutting end 42 that has thread-cutting teeth 44 slightly larger in diameter than an internal, reduced diameter portion 45 of the tubular outer valve cartridge casing 38 so that the tap 40 can be rotated to cut threads 46 (FIG. 5) in the internal, reduced diameter portion 45 of the valve cartridge casing 38.

As best shown in FIG. 2, the preferred tap 40 has the thread cutting end 42, e.g., ½ inch diameter, 24 teeth per inch, integrally connected to an elongated shaft 48 that is integrally connected to a gripping handle 5, that preferably is attached at a right angle to the shaft 48, for applying substantial longitudinal force to the outer valve cartridge casing 38 for removal of the outer valve cartridge casing 38 by hand.

As shown in FIGS. 3 and 5, the tool kit preferably includes a tubular tap guide or alignment device 50 comprising an annular tube 52 having an outer diameter slightly smaller than an internal diameter of the outer valve cartridge casing 38, and having a centrally disposed aperture 54 slightly larger than the diameter of the teeth 44 (e.g., 0.5 inch) of the tap 40. In the preferred embodiment, the tap has teeth 44 that cut threads that are ½ inch in diameter, 20 threads per inch, having raised portions between threads that are 29/64 inch in diameter. The tap alignment device includes an integral collar 56, including a stop surface 58 for aligning the tap alignment device within the outer valve cartridge casing 38, as shown in FIG. 5. To remove the outer valve cartridge casing 38, after removal of the internal valve cartridge structure 34, the tap alignment device 50 is inserted into the outer valve cartridge casing 38 so that stop surface 58 is in contact with an upper, annular surface 60 of the outer valve cartridge casing 38, and the tap 40 is inserted into the casing 38, through aperture 54 to maintain the teeth 44 of tap 42 in longitudinal alignment with a central longitudinal axis of the casing 38. In this manner, when the tap 40 is rotated to cut threads 46 in the narrowed internal wall 45 of the outer valve cartridge casing 38, the threads will be evenly cut in the narrowed wall 45 so that the cut threads 46 are longitudinally aligned with the longitudinal axis of the outer valve cartridge casing 38.

Other features, advantages, and specific embodiments of this invention will become readily apparent to those exercising ordinary skill in the art. Moreover, while specific embodiments of this invention have been described in considerable detail, variations and modifications of these embodiments can be effected without departing from the spirit and scope of this invention as disclosed and claimed.

1. A plumbing cartridge removal tool for removing a valve cartridge from a plumbing conduit, said valve cartridge including an internally threaded aperture, comprising:
an elongated shaft having a gripping handle, and an externally threaded stem, adapted to be secured to the threaded aperture of said valve cartridge, and extending from a distal end of the shaft;
a slide hammer stop secured to said elongated shaft for receiving force from a slide hammer to force the elongated shaft in a longitudinal direction; and
a slide hammer slidably mounted over the elongated shaft between the slide hammer stop and the threaded stem.

2. The valve cartridge removal tool of claim 1, wherein the threaded stem of said elongated shaft comprises a removable structure comprising a threaded stem at its distal ends including a first threaded stem portion adapted for threaded engagement with internal threads in a distal end of the elongated shaft, and a second threaded stem portion adapted for threaded engagement with the internal threads of the valve cartridge.

3. The valve cartridge removal tool of claim 2, wherein the elongated shaft includes an externally threaded portion adapted to threadedly engage an internally threaded portion of the valve cartridge, wherein the internally threaded portion of the valve-cartridge is formed therein during valve cartridge removal.

4. A valve cartridge removal kit for removing a valve cartridge from a plumbing conduit, said valve cartridge comprising a tubular outer cartridge casing containing rotatable internal valve structure capable of opening and closing the valve upon rotation, including an internally threaded aperture integral with said internal valve structure, comprising:
a first tool comprising:
an elongated shaft having a gripping handle, and an externally threaded stem, adapted to be secured to the threaded aperture of said valve cartridge; and extending from a distal end of the shaft;
a slide hammer stop secured to said elongated shaft for receiving force from a slide hammer to force the elongated shaft in a longitudinal direction; and
a slide hammer slidably mounted over the elongated shaft between the slide hammer stop and the threaded stem; and
b. a second tool comprising a tap, having a gripping handle, for cutting internal threads in an inside diameter of the tubular outer cartridge casing and to grip the outer cartridge on an inner surface at the formed threads after removal of the internal valve structure with the first device so that longitudinal force applied to the tap will force the valve cartridge out of the plumbing conduit.

5. The valve cartridge removal kit of claim 4, further including a third tool comprising a tubular tap guide adapted to be received within the tubular outer valve cartridge casing after removing the internal valve structure for guiding the tap longitudinally into the outer valve cartridge casing.

6. The valve cartridge removal kit of claim 4, wherein the threaded stem of said elongated shaft of the first tool comprises a removable structure comprising a threaded stem at its distal ends including a first threaded stem portion adapted for threaded engagement with internal threads in a distal end of the elongated shaft, and a second threaded stem portion adapted for threaded engagement with the internal threads of the valve cartridge.

7. The valve cartridge removal kit of claim 6, wherein the elongated shaft includes an externally threaded portion adapted to threadedly engage the internally threaded portion of the outer valve cartridge formed therein by the tap during outer valve cartridge removal.

8. A method of removing a valve cartridge from a plumbing conduit comprising:
threadedly connecting an externally threaded portion of an elongated shaft to an internally threaded portion of the valve cartridge; and
providing longitudinal force to said elongated shaft with a slide hammer sufficient to remove the valve cartridge.

9. A method in accordance with claim 8, further including repeatedly sliding the slide hammer longitudinally over said elongated shaft, against said slide hammer stop surface, whereby the valve cartridge is partially removed from the plumbing conduit upon each repeated contact against the slide hammer stop surface, until the valve cartridge is completely removed from the plumbing conduit.

10. The method in accordance with claim 8, wherein longitudinal force is provided to said elongated shaft by sliding a slide hammer longitudinally over said elongated shaft, against a slide hammer stop surface that is integral with said elongated shaft, to provide longitudinal removal force sufficient to remove valve cartridge internal valve structure from a surrounding valve cartridge casing, leaving the valve cartridge casing in contact with the plumbing conduit; and further including the steps of
forming internal threads into an internal surface of the valve cartridge casing; and
applying longitudinal force on said valve cartridge casing sufficient to remove said casing through a device threadedly connected to said valve cartridge casing at said formed internal threads.

11. A method in accordance with claim 10, wherein the internal threads are formed by rotating a tapping device within the valve cartridge casing, and the longitudinal force is exerted manually on the valve cartridge casing by pulling on the tapping device, while the tapping device is threaded into the formed threads.

12. A method in accordance with claim 10, wherein the threads are formed by inserting a tubular tap guide into an internal diameter of the valve cartridge casing to longitudinally align a tapping device internally within the valve cartridge casing; and
inserting and rotating the tapping device within the tubular tap guide to form the internal threads in the valve cartridge casing.

13. A method in accordance with claim 10 including the steps of:
forming internal threads in the valve cartridge casing with a tapping device;
removing the tapping device from the valve cartridge casing;
threadedly connecting an externally threaded elongated shaft to said formed internal threads within the valve cartridge casing; and
applying longitudinal removal force to said elongated shaft to remove the valve cartridge casing.

14. A method in accordance with claim 13, wherein the longitudinal removal force applied to said elongated shaft for removal of the valve cartridge casing is applied by sliding a slide hammer longitudinally over said elongated shaft, against a slide hammer slide surface that is integral with said elongated shaft.

15. A method in accordance with claim 14, wherein the elongated shaft and slide hammer are the same elongated shaft and slide hammer used to remove the internal value structure from the valve cartridge.
